(19) United States
(12) Patent Application Publication
(10) Pub. No.: US 2018/0270571 A1
(43) Pub. Date: Sep. 20, 2018

(54) TECHNIQUES FOR AMPLIFYING SOUND BASED ON DIRECTIONS OF INTEREST

(71) Applicant: HARMAN INTERNATIONAL INDUSTRIES, INCORPORATED, Stamford, CT (US)

(72) Inventors: Davide DI CENSO, Oakland, CA (US); Stefan MARTI, Oakland, CA (US); Jaime Elliot NAHMAN, Oakland, CA (US); Mirjana SPASOJEVIC, Palo Alto, CA (US)

(21) Appl. No.: 15/541,459

(22) PCT Filed: Jan. 20, 2016
(86) PCT No.: PCT/US2016/014173

§ 371 Date: Jul. 3, 2017

Related U.S. Application Data
(60) Provisional application No. 62/106,171, filed on Jan. 21, 2015.

(51) Int. Cl. H04R 1/40; H04R 3/12; G10K 11/175; G06F 3/01

(52) U.S. Cl. CPC H04R 1/403; H04R 3/12; H04R 2499/13; G06F 3/013; H04R 2430/01; G10K 11/175

(57) ABSTRACT

An amplification system selectively amplifies acoustic signals derived from a particular direction or a particular acoustic source. A user of the amplification system may indicate the direction of interest by facing a specific direction or looking in a particular direction, among other possibilities. The amplification system identifies the direction of interest and may then amplify acoustic signals originating from that direction. The amplification system may alternatively identify a particular acoustic source within the direction of interest, and then amplify acoustic signals originating from that source, continuously tracking the source.

### CROSS-REFERENCE TO RELATED APPLICATIONS

This application claims the benefit of U. S. provisional patent application titled “Directional Hearing Enhancement Based on Eye Direction/Contact,” filed on Jan. 21, 2015 and having Ser. No. 62/106,171. The subject matter of this related application is hereby incorporated herein by reference.

### FIELD OF THE DISCLOSED EMBODIMENTS

The disclosed embodiments relate generally to audio systems and, more specifically, to techniques for amplifying sound based on directions of interest.

### DESCRIPTION OF THE RELATED ART

A conventional audio system, such as a pair of headphones, ear buds, hearing aids, or an in-vehicle infotainment system, generally outputs acoustic signals to a user. Those acoustic signals could be derived from a recorded digital media, or derived from ambient and/or environmental sounds. For example, a set of headphones coupled to a compact disc (CD) player could output music derived from a CD, or a set of hearing aids could output sound derived from the acoustic environment surrounding the user.

One drawback of conventional audio systems, such as those described above, is that conventional systems generally decrease or increase the amplitude of all of the sounds received at the position of the user without accounting for whether certain sounds are particularly interesting or important to the user. For example, a set of over-ear headphones generally reduces the amplitude of sounds derived from the surrounding acoustic environment in order to isolate the user from those sounds and cause music output by the headphones to be more easily heard. However, this situation can be problematic if the user wants to interact with another person while wearing the headphones. Conversely, conventional hearing aids generally increase the amplitude of all sounds received from the acoustic environment in order to allow the user to better hear those sounds. However, when the user is faced with a very loud or high-pitched source of sound from the acoustic environment, such as an emergency vehicle siren, this amplification may be undesirable. In cases such as these, conventional audio systems generally provide little or no selectivity regarding which sounds and/or acoustic sources associated with the acoustic environment the user is permitted to hear.

As the foregoing illustrates, techniques for selectively amplifying certain sounds of interest to users would be useful.

### SUMMARY

One or more embodiments set forth include a non-transitory computer-readable medium storing instructions that, when executed by a processor, configure the processor to selectively amplify acoustic signals by performing the steps of determining a direction of interest associated with the user, identifying, from within a set of acoustic signals associated with a current environment surrounding the user, a subset of acoustic signals associated with the direction of interest, amplifying the subset of acoustic signals, and outputting the amplified subset of acoustic signals to the user.

At least one advantage of the disclosed techniques is that the amplification system may eliminate unwanted acoustic signals as well as amplify desirable acoustic signals, thereby providing the user with increased control over the surrounding acoustic environment.

### BRIEF DESCRIPTION OF THE SEVERAL VIEWS OF THE DRAWINGS

So that the manner in which the recited features of the one more embodiments set forth above can be understood in detail, a more particular description of the one or more embodiments, briefly summarized above, may be had by reference to certain specific embodiments, some of which are illustrated in the appended drawings. It is to be noted, however, that the appended drawings illustrate only typical embodiments and are therefore not to be considered limiting of its scope in any manner, for the scope of the disclosed embodiments subsumes other embodiments as well.

FIGS. 1A-1D illustrate elements of an amplification system configured to implement one or more aspects of the various embodiments;

FIGS. 2A-2C illustrate the amplification system of FIGS. 1A-1D continuously amplifying acoustic signals associated with a range of directions, according to various embodiments;

FIGS. 3A-3C illustrate the amplification system of FIGS. 1A-1D amplifying acoustic signals derived from a specific direction or a specific source that is indicated by the user, according to various embodiments;

FIGS. 4A-4B illustrate how the amplification system of FIGS. 1A-1D can amplify acoustic signals to facilitate social interactions, according to various embodiments;

FIG. 5 illustrates how the amplification system of FIGS. 1A-1D can amplify acoustic signals echoed from different surfaces, according to various embodiments;

FIGS. 6A-6B illustrate the amplification system of FIGS. 1A-1D transducing environmental sounds into a vehicle based on the directions of interest of the vehicle occupants, according to various embodiments;

FIG. 7 is a flow diagram of method steps for amplifying acoustic signals derived from a specific direction of interest, according to various embodiments; and

FIG. 8 is a flow diagram of method steps for amplifying acoustic signals derived from a specific acoustic source of interest, according to various embodiments.

### DETAILED DESCRIPTION

In the following description, numerous specific details are set forth to provide a more thorough understanding of certain specific embodiments. However, it will be apparent to one of skill in the art that other embodiments may be practiced without one or more of these specific details or with additional specific details.

### System Overview

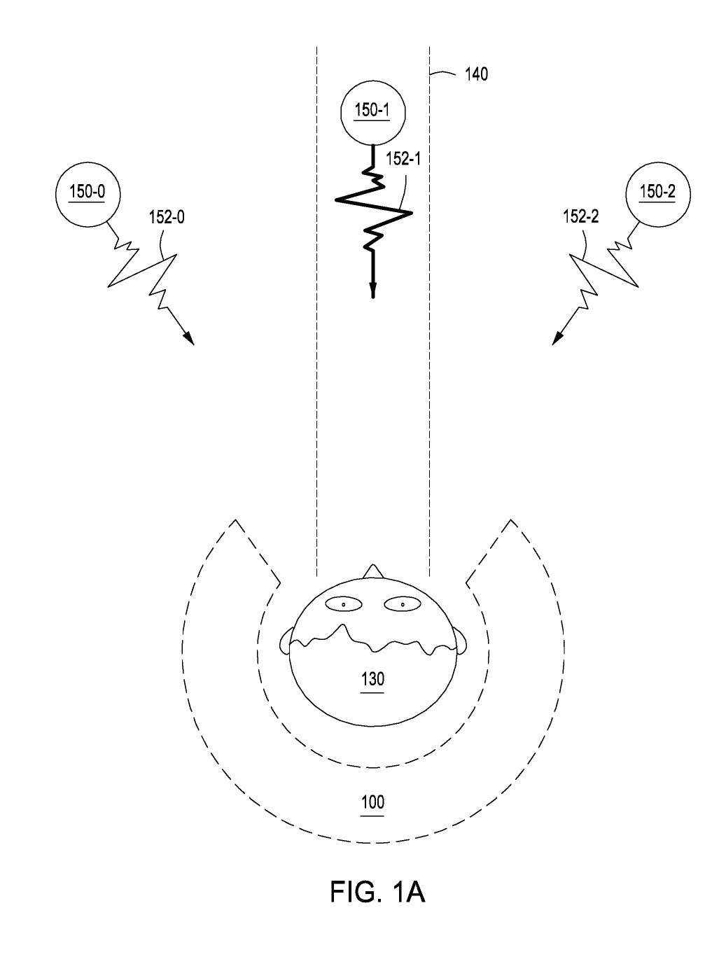

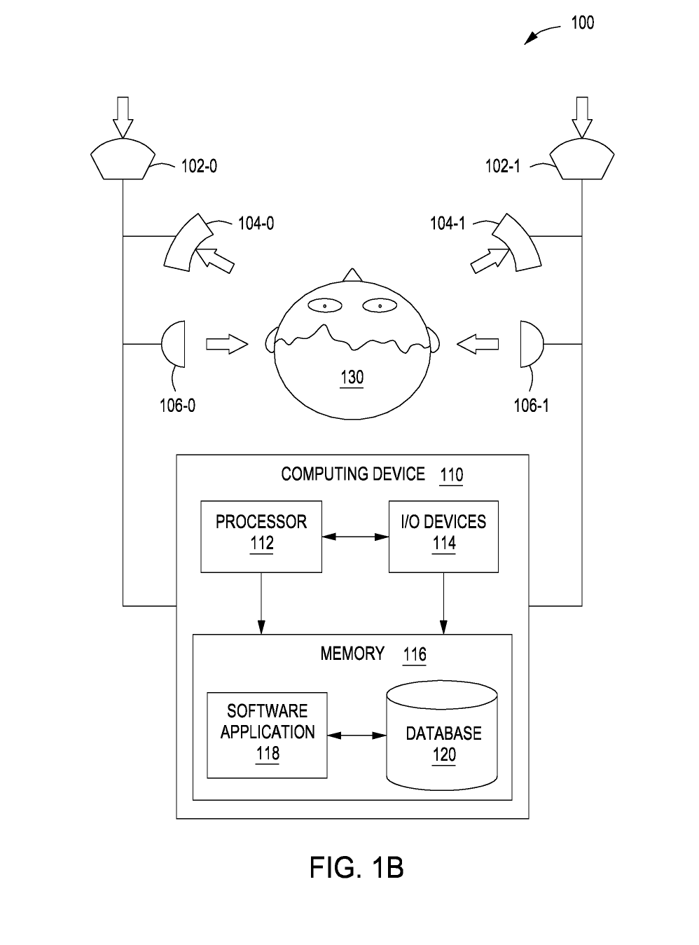

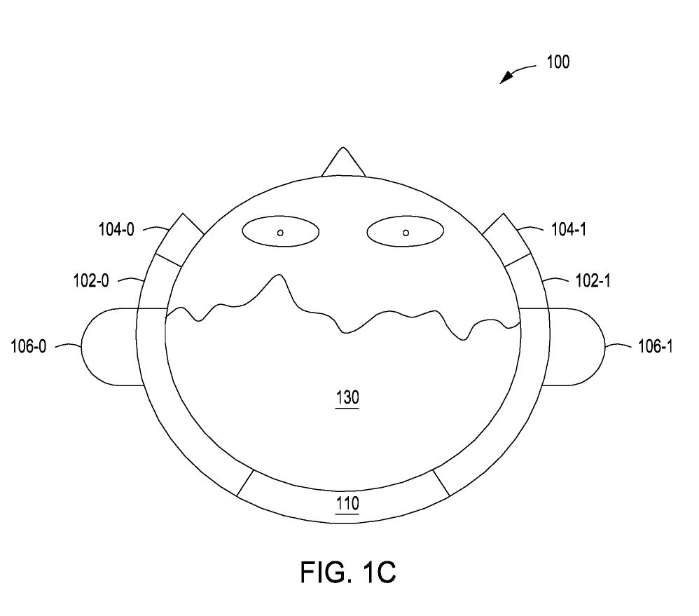

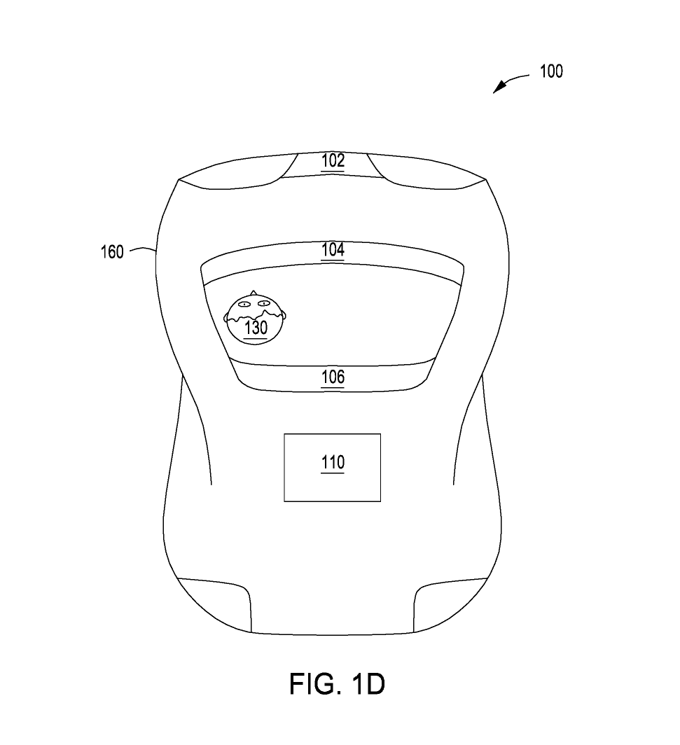

FIGS. 1A-1D illustrate elements of an amplification system configured to implement one or more aspects of the various embodiments. As shown in FIG. 1A, amplification system 100 is generally positioned on or around a user 130. Amplification system includes a variety of different types of input devices as well as output devices, as described in greater detail below in conjunction with FIG. 1B. Amplification system 100 may be incorporated into a head, ear, shoulder, or other type of body—mounted system, such as that described below in conjunction with FIG. 1C, or integrated into another system, such as a vehicle, for example and without limitation, as described in greater detail below in conjunction with FIG. 1D.

In operation, amplification system 100 is configured to receive sensor data associated with user 130, and to then determine a direction of interest 140 associated with user 130. Direction of interest 140 may correspond to a direction that user 130 is facing. Accordingly, amplification system 100 may be configured to detect the orientation of the head of user 130, and to then compute direction of interest 140 based on that head orientation. Alternatively, direction of interest 140 may correspond to a direction that user 130 is looking. In such cases, amplification system 100 may be configured to detect an eye gaze direction associated with user 130, and to then compute direction of interest 140 to reflect that eye gaze direction. Once amplification system 100 determines direction of interest 140, amplification system 100 may then amplify acoustic signals associated with that direction. Direction of interest 140 may also correspond to other directions associated with user 130, such as, for example and without limitation, a direction that user 130 is pointing, a direction verbally indicated by user 130, a direction that user 130 is walking or running, a direction that user 130 is driving, a direction of interest associated with one or more other people, and so forth.

In one embodiment, amplification system 100 receives acoustic signals from the environment proximate to user 130, and then identifies a subset of those acoustic signals that originate from within direction of interest 140. For example, and without limitation, in FIG. 1A, various acoustic sources 150 generate different acoustic signals 152, thereby creating an acoustic environment in the vicinity of user 130. A particular acoustic signal 152-1 originates from within direction of interest 140. Thus, in the embodiment described herein, amplification system 100 would amplify acoustic signal 152-1 and output the amplified acoustic signal 152-1 to user 130. In doing so, amplification system 100 may transduce acoustic signal 152-1 and then modulate the amplitude and/or frequencies of that signal. To modulate the amplitude and/or frequencies of the aforesaid acoustic signal, amplification system 100 may rely on any technically feasible digital signal processing techniques in order to generally improve that acoustic signal. Further, amplification system 100 may reduce and/or cancel acoustic signals 152-0 and 152-2, each of which originates from outside of direction of interest 140. To reduce and/or cancel such acoustic signals, amplification system may implement any technically feasible type of noise cancellation.

In another embodiment, amplification system 100 receives acoustic signals from the environment proximate to user 130, and then identifies a subset of those acoustic signals that originate from a specific acoustic source that resides within direction of interest 140. For example, and without limitation, in FIG. 1A, acoustic source 150-1 resides within direction of interest 140, and acoustic sources 150-0 and 150-2 do not. Thus, in the embodiment described herein, amplification system 100 would amplify any and all acoustic signals originating from acoustic source 150-1, including acoustic signal 152-1, and then output those amplified acoustic signals to user 130. In doing so, amplification system 100 may transduce acoustic signals derived from acoustic source 150-1 and then modulate the amplitude and/or frequencies of those signals. To modulate the amplitude and/or frequencies of the aforesaid acoustic signals, amplification system 100 may rely on any technically feasible form of digital signal processing techniques in order to generally improve those acoustic signals. Additionally, amplification system 100 may reduce and/or cancel acoustic signals derived from acoustic sources 150-0 and 150-2, each of which resides outside of direction of interest 140. To reduce and/or cancel such acoustic signals, amplification system may implement any technically feasible type of noise cancellation.

An advantage of amplification system 100 described above is that user 130 is provided with flexible control over the acoustic environment that user 130 perceives. In particular, user 130 may modify that perceived acoustic environment by shifting the direction of interest towards desirable acoustic sources and corresponding acoustic signals and away from undesirable acoustic sources and corresponding acoustic signals. The features provided by amplification system 100 may improve the overall acoustic experience of user 130. Persons skilled in the art will recognize that amplification system 100 described thus far may be implemented according to a wide variety of different mechanisms. FIG. 1B, described below, illustrates one exemplary implementation.

As shown in FIG. 1B, amplification system 100 includes outward facing sensors 102, inward facing sensors 104, output devices 106, and computing device 110, coupled together. Outward facing sensors 102 may include any technically form of sensor device, including acoustic sensors, visual sensors, radio frequency (RF) sensors, heat sensors, and so forth. Generally, outward facing sensors 102 include sufficient input devices to monitor, measure, transduce, or otherwise capture a complete panorama of the acoustic environment that surrounds user 130. In addition, outward facing sensors 102 may also include sufficient input devices to monitor, measure, transduce, or otherwise capture a specifically targeted portion of the acoustic environment that surrounds user 130. Outward facing sensors 102 could include, for example and without limitation, one or more microphones, microphone arrays, steerable or beam forming microphone arrays, static microphones, and/or adjustable microphones mounted to pan/tilt assemblies, among other possibilities. Outward facing sensors 102 may also include video sensors configured to identify particular objects residing proximate to user 130.

Similar to outward facing sensors 102, inward facing sensors 104 may include any technically feasible form of sensor device, including audio and/or video sensors. In general, inward facing sensors 104 include sufficient input devices to monitor, measure, transduce, or otherwise capture data associated with user 130 that reflects direction of interest 140. In particular, inward facing sensors 104 include input devices configured to measure one or more of the three-dimensional (3D) head orientation of user 130, the 3D eye gaze direction of user 130, blood flow associated with user 130, muscle contractions associated with user 130, neural activity of user 130, and so forth. Inward facing sensors 104 could include, for example and without limitation, a head orientation tracking device, an eye gaze tracking imager, a video camera configured to monitor the face of user 130, or a hand gesture sensor for identifying a pointing direction associated with user 130. A head orientation tracking device with inward facing sensors 104 could include, for example and without limitation, a magnetometer, an array of gyroscopes and/or accelerometers, or any combination thereof.

Output devices 106 may include any technically feasible form of acoustic transducer. Output devices 106 generally include one or more speaker arrays configured to generate and output acoustic signals to user 130. In some embodiments, output devices 106 are implemented via headphones, ear buds, shoulder-mounted speakers, or other wearable, wired or wireless, audio devices, as also described below in conjunction with FIG. 1C. In other embodiments, output devices 106 are implemented via speaker assemblies mounted inside of a vehicle, as described below in conjunction with FIG. 1D.

Computing device 110 is coupled to outward facing sensors 102, inward facing sensors 104, and output devices 106, as is shown. Computing device 110 includes a processor 112, input/output (I/O) devices 114, and a memory 116 that includes a software application 118 and a database 120. Processor 112 may be any technically feasible hardware for processing data and executing applications, including, for example and without limitation, a central processing unit (CPU), an application specific integrated circuit (ASIC), a field-programmable gate array (FPGA), among others. I/O devices 114 may include devices for receiving input, such as a global navigation satellite system (GNSS), for example and without limitation, devices for providing output, such as a display screen, for example and without limitation, and devices for receiving input and providing output, such as a touchscreen, for example and without limitation. Memory 116 may be any technically feasible medium configured to store data, including, for example and without limitation, a hard disk, a random access memory (RAM), a read-only memory (ROM), and so forth.

Software application 118 includes program instructions that, when executed by processor 112, configure processor 112 to implement the overall functionality of amplification system 100. In doing so, software application 118 may cause processor 112 to receive input from outward facing sensors 102 and inward facing sensors 104, and to process that input to generate acoustic signal to be output to user 130 via output devices 106. Software application 118 may also store and retrieve data to and from database 120. Such data could include, for example and without limitation, user preferences regarding specific sources of sound that should be amplified, user configurations indicating particular regions of the environment that should be amplified, visual imagery indicating particular acoustic sources that should be amplified, and so forth.

As a general matter, the specific configuration of components shown in FIG. 1B is provided for exemplary and non-limiting purposes only. Amplification system 100 may be implemented according to a wide variety of different techniques, and integrated into a vast array of different consumer devices. Two non-limiting examples of devices configured to include amplification system 100 are described below in conjunction with FIGS. 1C and 1D, respectively.

As shown in FIG. 1C, amplification system 100 may be implemented as a head-mounted apparatus. In this configuration, amplification system 100 includes outward facing sensors 102, inward facing sensors 104, output devices 106, and computing device 110 integrated into a headphone apparatus that is sufficiently small as to be comfortably worn on the head of user 130. In a related embodiment, amplification system 100 may be miniaturized and implemented within one or more ear buds that can be worn in the ears of user 130. In a further embodiment, amplification system 100 may be sufficiently small as to fit into hearing aids that can be worn within the inner ear of user 130.

As shown in FIG. 1D, amplification system 100 may be implemented within a vehicle 160. Outward facing sensors 102 may be positioned on the exterior of vehicle 160 and configured to receive sensor data from an environment that surrounds vehicle 160. Inward facing sensors 104 may be mounted within the cabin of vehicle 160 and configured to receive sensor data associated with user 130 and/or one or more other occupants of vehicle 160. Output devices 106 may include a speaker array that forms a portion of an infotainment system. Computing device 110 may be an independent computing device within vehicle 110, or may be implemented as a portion of an on-board vehicle control computer system.

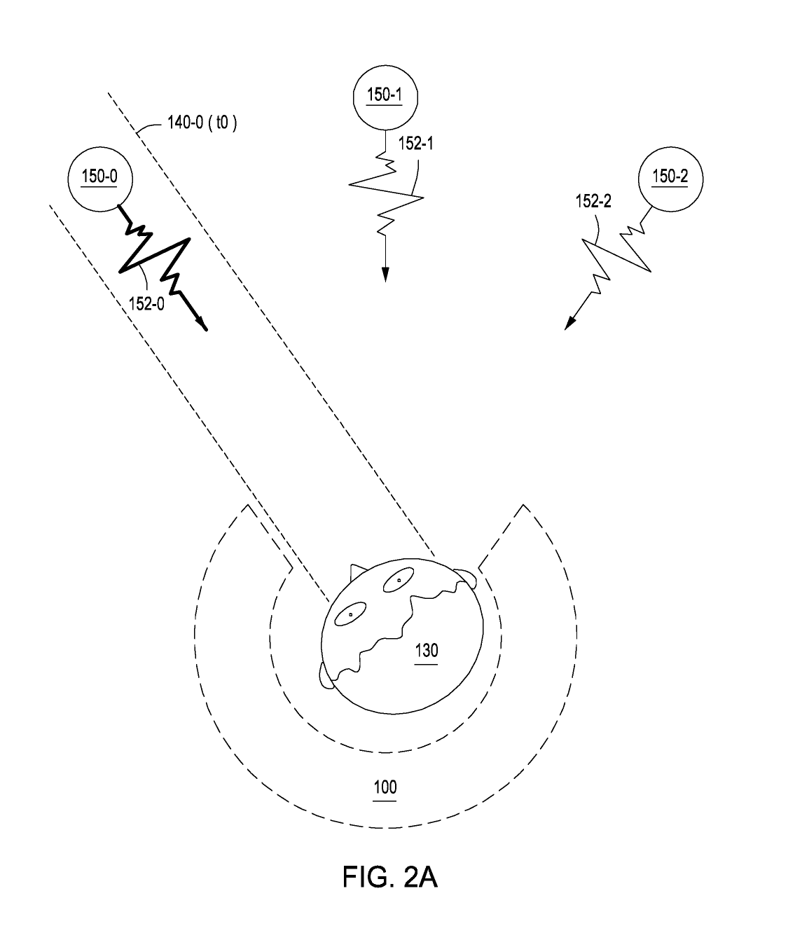

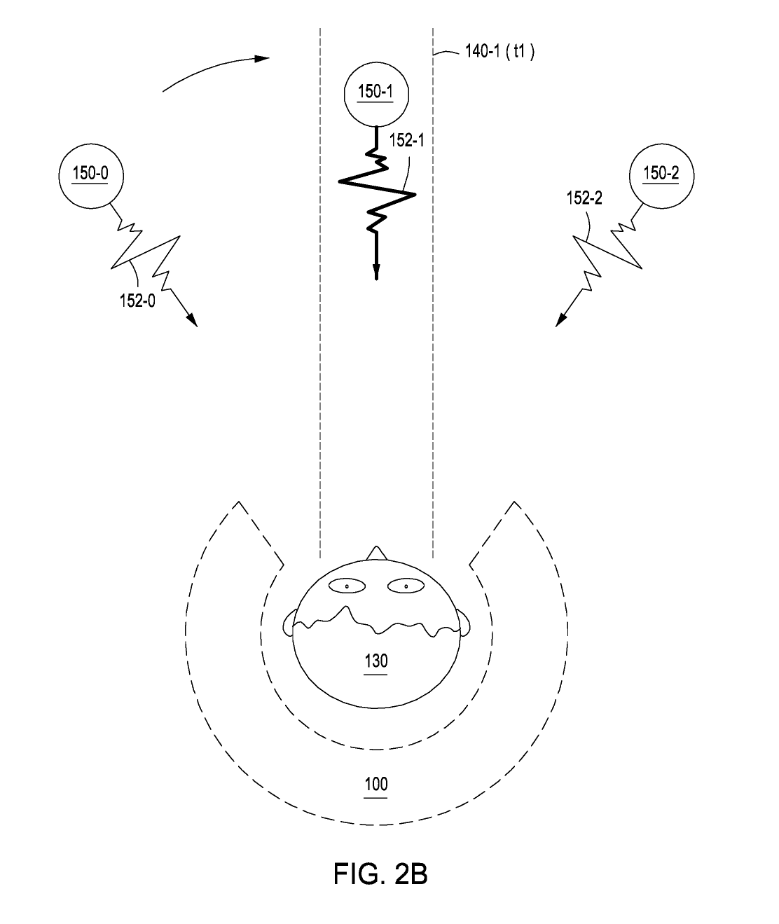

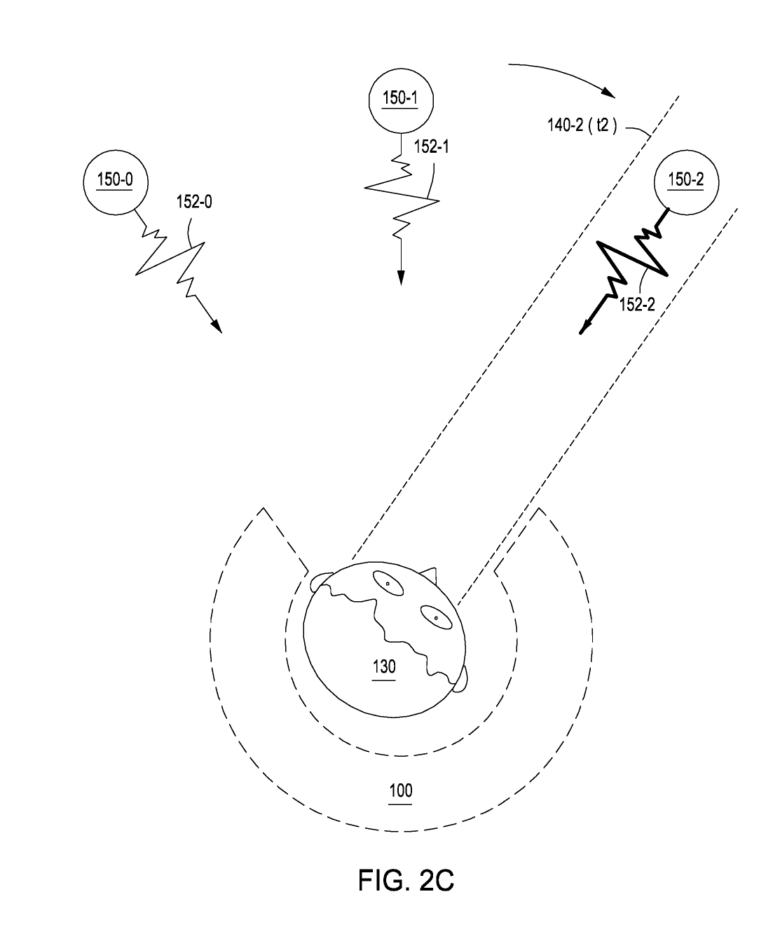

Referring generally to FIGS. 1A-1D, the various exemplary implementations described in conjunction with those figures facilitate a vast range of different usage scenarios to occur. FIGS. 2A-6B illustrate a collection of exemplary usage scenarios presented to illustrate only a fraction of the possible situations where amplification system 100 may provide benefits to user 130. Persons skilled in the art will recognize that the exemplary usage scenarios that follow are presented for illustrative purposes only and not meant to be imitating.

### Exemplary Usage Scenarios of the Amplification System

FIGS. 2A-2C illustrate the amplification system of FIGS. 1A-1D continuously amplifying acoustic signals associated with a range of directions, according to various embodiments. As shown in FIGS. 2A-2C, direction of focus 140 sweeps across the field of view of user 130 from left to right during times t0 through t2. In FIG. 2A, user 130 faces or looks in direction of interest 140-0 at time t0. Acoustic source 150-0 resides in direction of interest 140-0, and so at time t0, amplification system 100 amplifies acoustic signal 152-0. In FIG. 2B, user 130 faces or looks in direction of interest 140-1 at time t1. Acoustic source 150-1 resides in direction of interest 140-1, and so at time t1, amplification system 100 amplifies acoustic signal 152-1. In FIG. 2C, user 130 faces or looks in direction of interest 140-2 at time t2. Acoustic source 150-2 resides in direction of interest 140-2, and so at time t2, amplification system 100 amplifies acoustic signal 152-2.

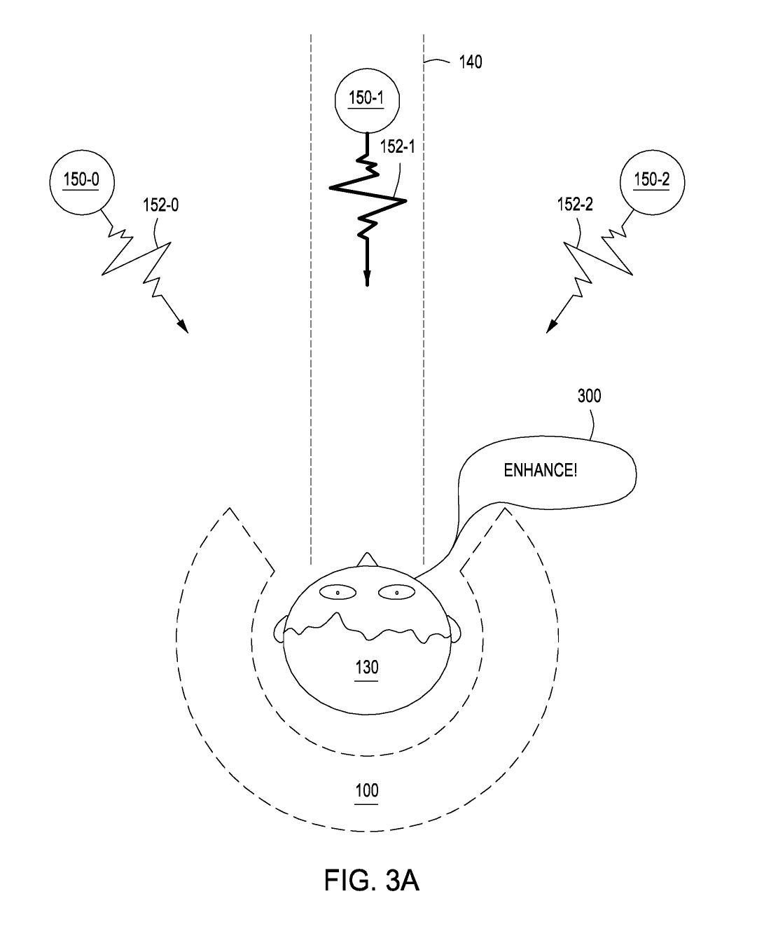

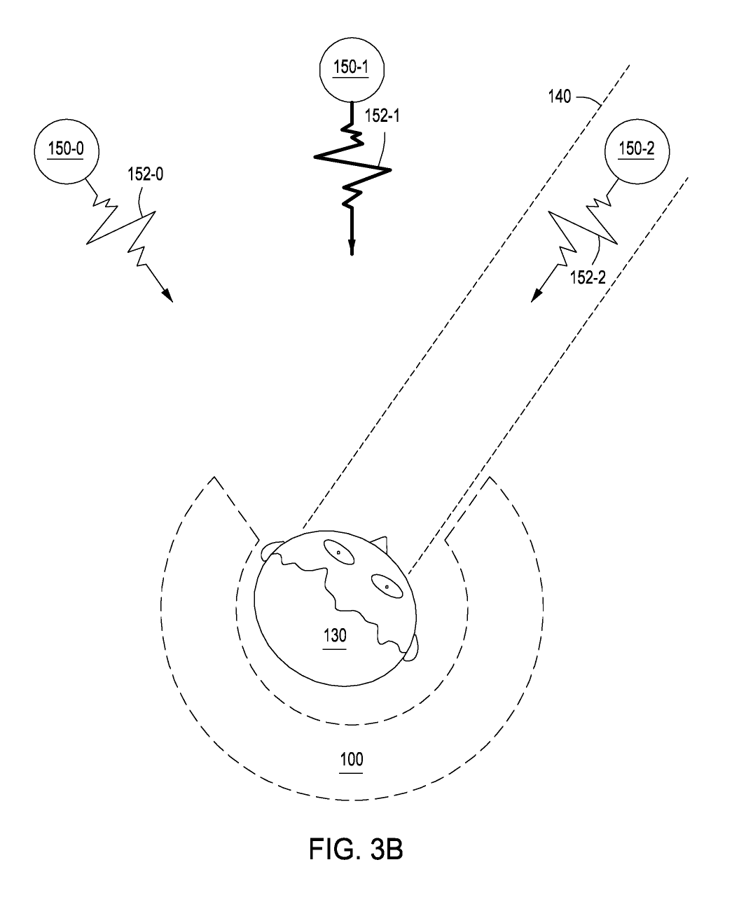

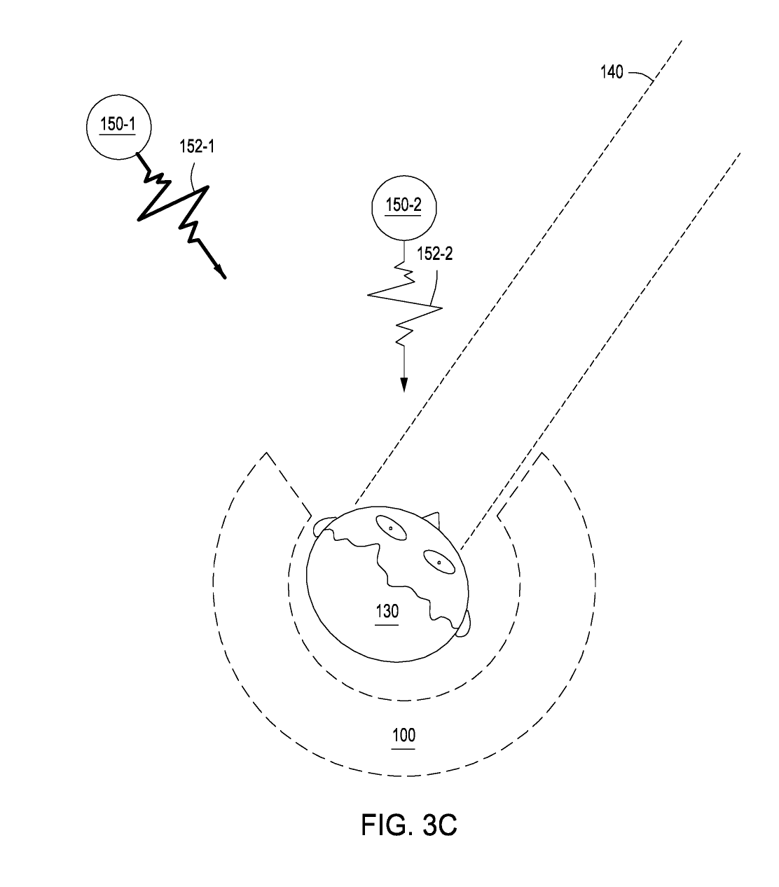

Referring generally to FIGS. 2A-2C, these figures are meant to illustrate that, in some operating modes, amplification system 100 continuously amplifies all sound that originates from the direction where user 130 faces or looks. Each different direction of interest 140 shown in these figures may represent an angular portion of a 360-degree panorama, or a cone of 3D space derived from a spherical region that surrounds user 130. The specific size and shape of direction of focus 140 may be configurable based on user preferences, based on the distance between user 130 and various acoustic sources, or based on other parameters. Amplification system 100 may also be configured amplify acoustic signals and/or acoustic sources in response to feedback received from user 130, as described in greater detail below in conjunction with FIGS. 3A-3C.

FIGS. 3A-3C illustrate the amplification system of FIGS. 1A-1D amplifying acoustic signals derived from a specific direction or a specific source that is indicated by the user, according to various embodiments. As shown in FIG. 3A, direction of focus 140 lies directly ahead of user 130 and includes acoustic source 150-1, which generates acoustic signal 152-1. In the exemplary usage scenarios discussed herein, amplification system 100 may abstain from amplifying acoustic signals until commanded to do so by user 130. In FIG. 3A, user 130 speaks command 300, which indicates that amplification system 100 should begin enhancing acoustic signals. Accordingly, amplification system 100 begins amplifying acoustic signal 152-1. Amplification system may be responsive to any technically feasible form of command beyond command 300, including, for example, and without limitation, gestural commands, facial expressions, user interface commands, commands input via a mobile device, and so forth. In addition, amplification system 100 may be configured to receive input indicating a specific amount of amplification desired, or a specific acoustic source that should be tracked. For example, and without limitation, amplification system 100 could receive a command indicating that the sound of a particular vehicle should be amplified by a certain amount. Amplification system 100 would rely on computer vision techniques to identify the vehicle, and then provide the desired level of amplification.

In one embodiment, amplification system 100 may continue enhancing acoustic signals that originate from the direction currently associated with direction of focus 140, regardless of whether user 130 continues to look or face that direction. This embodiment is described by way of example below in conjunction with FIG. 3B. In another embodiment, amplification system 100 may continue to enhance acoustic signals that originate from acoustic source 150-1, regardless of whether that acoustic source remains in direction of focus 140, as described below in conjunction with FIG. 3C.

As shown in FIG. 3B, user 130 looks or faces in a different direction, and so direction of focus 140 has moved accordingly. However, amplification system 100 continues to amplify acoustic signals originating from directly in front of user 130. Thus, amplification system 100 continues to amplify acoustic signal 150-1 despite the fact that user 130 faces or looks elsewhere. In performing the technique described in conjunction with this embodiment, amplification system 100 may rely on a variety of techniques to maintain the direction from which acoustic signals are amplified, independent of the current direction of interest. For example, and without limitation, amplification system 100 could include a compass, and then continuously amplify acoustic signals that derive from a particular direction. Alternatively, amplification system could rely on GNSS coordinates associated with a user-selected direction and then continuously amplify acoustic signals associated with that direction. Amplification system 100 may also be configured to track and amplify specific sources of sound, as described in greater detail below in conjunction with FIG. 3C.

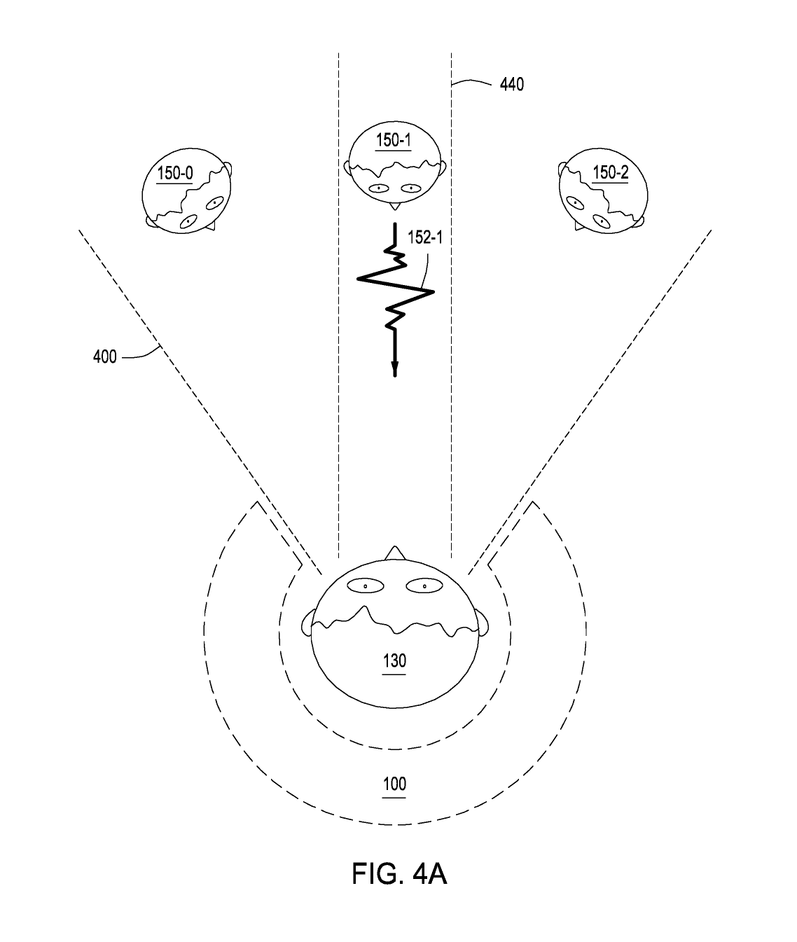

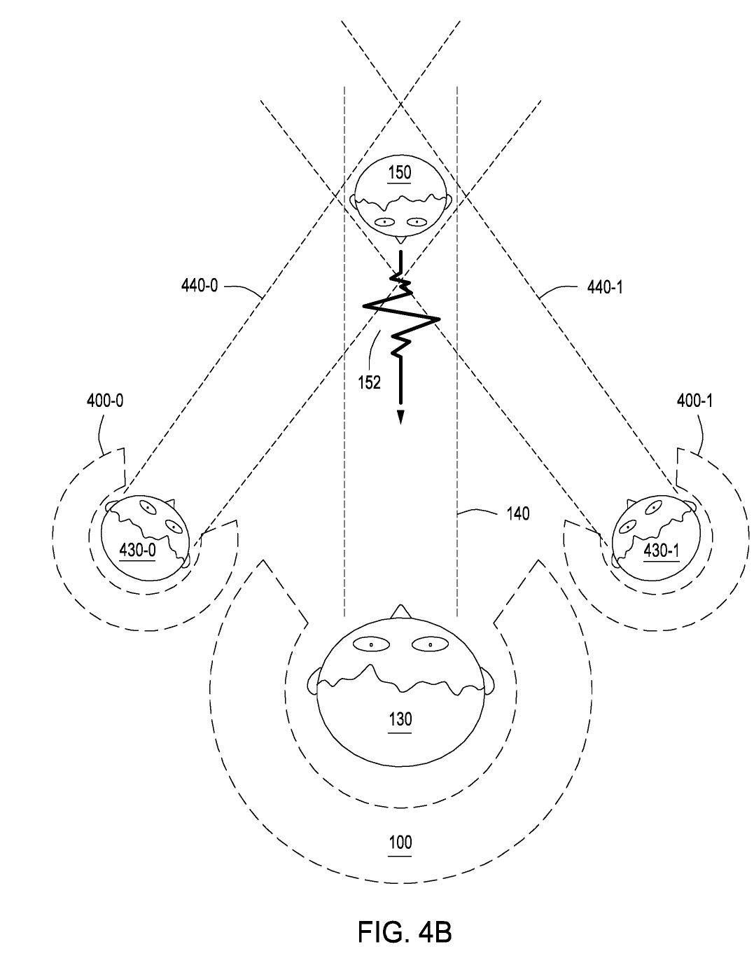

As shown in FIG. 3C, acoustic source 150-0 is no longer present and acoustic sources 150-1 and 150-2 have changed positions. In addition, direction of focus 140 has moved. As mentioned above in conjunction with FIG. 3A, in certain embodiments, amplification system 100 is configured to identify specific acoustic sources and to then track and amplify those acoustic sources regardless of changes to direction of focus 140. In FIG. 3A, when user 130 issues command 300, amplification system 100 may identify acoustic source 150-1 as the particular source that user 130 wishes to be amplified. Then, in situations where acoustic source 150-1 moves and/or direction of focus 140 changes, as shown in FIG. 3C, amplification system 100 continues to amplify acoustic signals 152-1 generated by acoustic source 150-1. In doing so, amplification system 100 may identify a characteristic set of frequencies associated with acoustic source 150-1 and then continuously amplify acoustic signals matching those characteristic frequencies. Alternatively, amplification system 100 may visually track acoustic source 150-1, via outward facing sensors 102, and then employ a beam forming microphone (included in outward facing sensors 102) to collect acoustic signals originating from that source. Amplification system 100 may also facilitate social interactions between people by selectively amplifying speech, as described below in conjunction with FIGS. 4A-4B.

FIGS. 4A-4B illustrate how the amplification system of FIGS. 1A-1D can amplify acoustic signals to facilitate social interactions, according to various embodiments. As shown in FIG. 4A, sources 150 described above are now depicted as people. User 130 may be engaged in conversation, and may thus receive acoustic signals in the form of speech. Amplification system 100 may operate in a particular mode to identify that user 130 is engaged in conversation, and to then track the speech signals generated by the participants in that conversation. In doing so, amplification system 100 may generate a global scope of interest 400, as well as a more specific direction of interest 440. Scope of interest 400 includes specific acoustic sources 150, residing within scope of interest 400, which user 130 may wish to have amplified. Direction of interest 440 includes one specific acoustic source, acoustic source 150-1, that generates acoustic signal 152-1. Amplification system 100, accordingly, amplifies acoustic signal 152-1.

The particular technique described herein may be advantageously applied in situations where multiple people engage in conversational turn taking behavior. Amplification system 100 may identify such scenarios, and then track the particular person currently speaking in turn. Amplification system 100 may amplify the speech sounds produced by that person. Since conversational turn taking may be aperiodic and unpredictable, amplification system 100 may rapidly and dynamically identify different directions of interest associated with a currently speaking person. Multiple instances of amplification system 100 may also be configured to communicate with one another in order to selectively amplify acoustic signals, as described below in conjunction with FIG. 4B.

As shown in FIG. 4B, user 130 resides in a social group that includes users 430-0 and 430-1. Each user 430 is associated with an instance of amplification system 100. User 430-0 is associated with amplification system 400-0, and user 430-1 is associated with amplification system 400-1. Each of user 130 and users 430 directs attention to acoustic source 150, which, in this example, is depicted as a person. Amplification system 100 determines direction of focus 140 for user 130. Amplification system 400-0 determines a direction of interest 440-0 for user 430-0, and amplification system 400-1 determines a direction of interest 440-1 for user 430-1. Amplification systems 100 and 400 are configured to interoperate in order to determine that directions of interest 140 and 440 converge onto a single region of 3D space or a single acoustic source. Then, amplification systems 100 and 400 may amplify acoustic signals derived from that region and/or source. In the example shown, each of amplification systems 100 and 400 may amplify acoustic signal 152 that originates from acoustic source 150.

This particular technique may be beneficial in a lecture scenario, where one speaker speaks more frequently than others. Since the one speaker may move about when speaking, the approach described herein may be applied to reliably track the location of that speaker based on the collective directions of interest associated with an audience of people. The technique described herein may also be implemented to track and amplify non-human sources of sound. For example, in FIG. 4B, acoustic source 150 could be an automobile, and amplification systems 100 and 400 could amplify the sounds of that automobile for users 130 and 430 based on the collective gaze (which indicates collective interest) of those users.

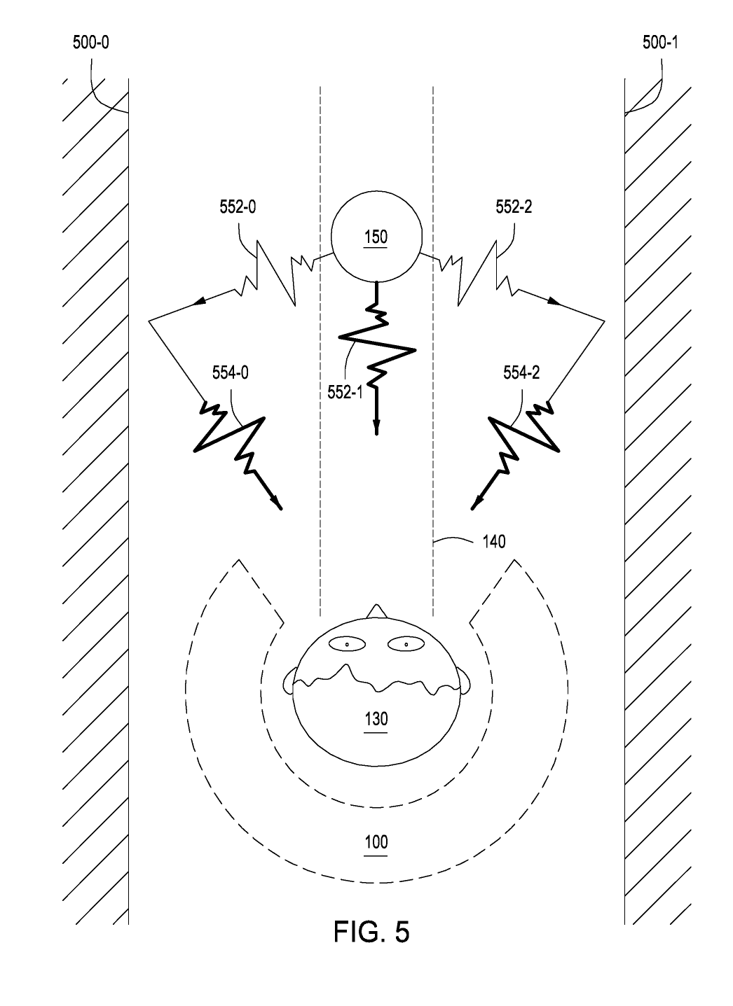

Referring generally to FIGS. 4A-4B, the techniques described herein may be implemented in conjunction with one another in order to facilitate social interactions between people. For example, the approach to detecting turn taking, described in conjunction with FIG. 4A, may be combined with the approach for identifying the current speaker, described in conjunction with FIG. 4B, to improve the amplification of the current speaker. In further embodiments, amplification system 100 may rely on mutual eye contact between individuals in order to establish the particular speaker to amplify. In such embodiments, amplification based on the detection of eye contact may supersede the amplification of other acoustic signals. For example, and without limitation, in a lecture scenario, as described above, two audience members may wish to engage in a private conversation while the lecturer speaks. When the two audience members make eye contact, the respective amplification systems associated with those users could stop amplifying the lecturer, and then only amplify the respective users, thereby facilitating that private conversation. Amplification system 100 may also be configured to intelligently track and amplify echoes, thereby creating a richer acoustic experience for user 130, as described below in conjunction with FIG. 5.

FIG. 5 illustrates how the amplification system of FIGS. 1A-1D can amplify acoustic signals echoed from different surfaces, according to various embodiments. As shown in FIG. 5, user 130 resides in a location where surfaces 500 are disposed on either side of user 130. Acoustic source 150 resides in front of user 130. Amplification system 100 is configured to identify direction of focus 140, based on the direction user 130 is facing or looking, and then determine that acoustic signals originating from within that direction should be amplified, in the manner discussed previously. Accordingly, amplification system 100 amplifies acoustic signal 552-1.

Acoustic source 150 also generates acoustic signals 552-0 and 552-2, and these signals are reflected from surfaces 500-0 and 500-1, respectively, towards user 130 as echoes 554-0 and 554-2. Echoes 554-0 and 554-2 do not directly originate from within direction of focus 140, as does acoustic signal 552-1, yet because these echoes 554 are derived from acoustic signals that do, in fact, originate from within direction of focus 140, amplification system 100 is configured to amplify echoes 554-0 and 554-2 as well. To do so, amplification system 100 may process acoustic and/or visual input received via outward facing sensors 102 in order to determine the specific location and geometry of surfaces 500. Based on the location of acoustic source 150, amplification system 100 may then determine that echoes 554 originated from that source. Alternatively, amplification system 100 may identify a characteristic set of frequencies associated with acoustic signal 552-1, and then determine that echoes 554 also include that same characteristic set of frequencies, and therefore likely originate from acoustic source 150 as well. Then, amplification system 100 could amplify echoes 554.

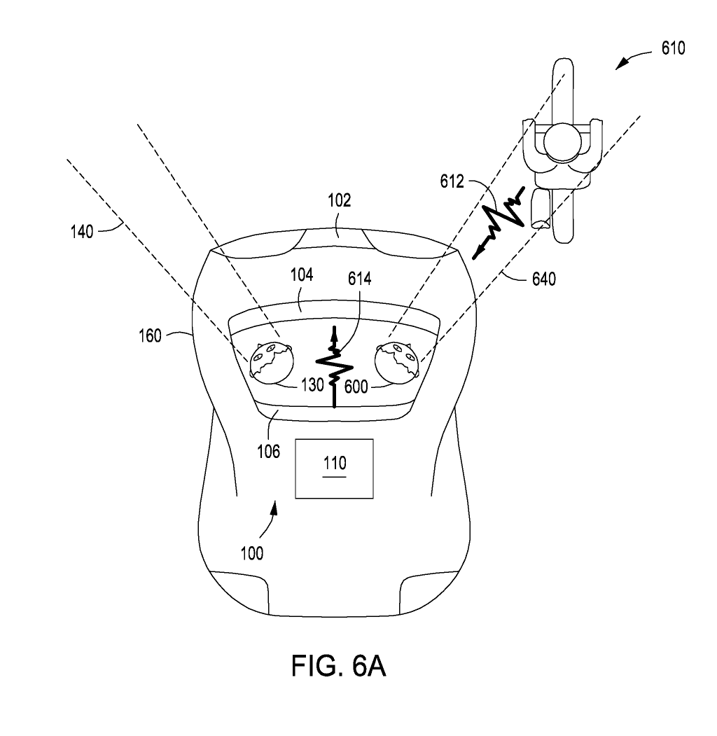

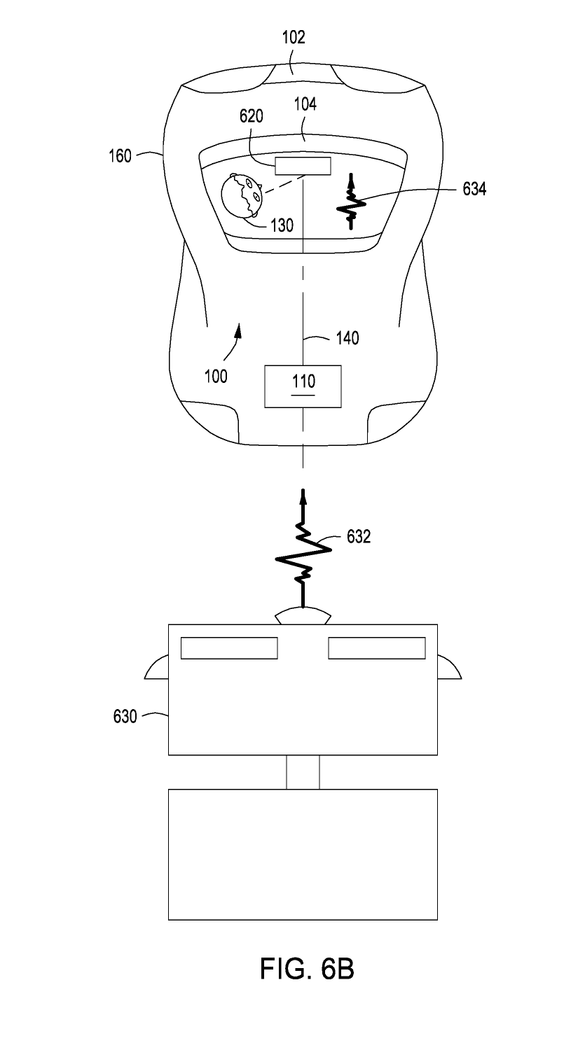

The technique described above for identifying and amplifying echoes may provide a more complete acoustic experience for user 130. In particular, echoes form a fundamental part of the everyday acoustic experience of a person, and without such echoes the amplified acoustic signals generated by amplification system 100 may sound unrealistic. This principle can be illustrated by way of non-limiting example. Suppose user 130 attends a symphony orchestra at a concert hall specifically designed with architectural features that enhance the acoustic experience. These architectural features, as known to those familiar with acoustics, generate myriad acoustic reflections, echoes, which enrich the experience of the audience. If amplification system 100 only amplified sounds originating from the direction of focus of user 130, then these echoes would be underrepresented because the loudness ratio between the (direct) acoustic signal 522-1 and (indirect) echoes 554 would be changed. Thus, the overall acoustic experience could be diminished. However, the technique described above mitigates this potential issue. Amplification system 100 may also be configured to mitigate other issues, with specific importance in the context of in-vehicle implementations, as described in greater detail below in conjunction with FIGS. 6A-6B.

FIGS. 6A-6B illustrate the amplification system of FIGS. 1A-1D transducing environmental sounds into a vehicle based on the direction of interest of the vehicle occupants, according to various embodiments. As shown in FIG. 6A, user 130 resides within vehicle 160 shown in FIG. 1D along with a passenger 600. User 130 looks towards the left side of vehicle 160 along direction of interest 140. Passenger 600 looks towards the right side of vehicle 160 along direction of interest 640. Passenger 600 sees motorcycle 610 driving dangerously close to vehicle 160. Motorcycle 610 generates acoustic signal 612. User 130 may not see or hear motorcyclist 610, which could potentially be dangerous. Amplification system 100, however, employs techniques to mitigate that danger, as described below.

Amplification system 100, integrated into vehicle 160 in this embodiment, is configured to determine direction of interests 140 and 640 associated with user 130 and passenger 600, and to amplify acoustic signals associated with either or both of those directions. Thus, when passenger 600 looks towards motorcycle 610, amplification system 100 determines direction of interest 640 and then amplifies acoustic signal 612. Amplification system 100 then transduces an amplified version of acoustic signal 612 (shown as acoustic signal 614) into the cabin of vehicle 160, thereby allowing user 130 to hear that acoustic signal and react accordingly. In various embodiments, amplification system 100 may use 3D sound techniques to output acoustic signal 614 to user 130 and passenger 600 such that acoustic signal 614 appears to originate from motorcycle 610. Amplification system 100 is also configured to amplify acoustic signals in situations where user 130 relies on mirrors within vehicle 160 to identify other automobiles, as described in greater detail below in conjunction with FIG. 6B.

As shown in FIG. 6B, user 130 drives vehicle 160 in front of a tractor-trailer 630. Tractor-trailer 630 is approaching vehicle 160 and generating acoustic signal 632. User 130 may not immediately see tractor-trailer 630 until user 130 looks into rear-view mirror 620. Then, user 130 may see tractor-trailer 630 along direction of focus 140. Amplification system 100 is configured to identify that direction of focus 140 is reflected from rear-view mirror 620, and to then identify that tractor-trailer 630 resides within that direction of focus. Amplification system 100 may then amplify acoustic signal 632, and transduce an amplified version of that signal into the cabin of vehicle 160 as acoustic signal 634. Amplification system 100 may also transduce other environmental sounds as well, although at a lower volume level. As with the example described above in conjunction with FIG. 6A, amplification system 100 may implement 3D sound techniques to preserve the directionality of amplified acoustic signal 634 to reflect that of acoustic signal 632. With this approach, amplification system 100 remains aware of the actual real-world direction where user 130 is facing or looking, regardless of whether mirrors are employed. Since drivers of vehicles routinely rely on mirrors to maintain awareness of the road, the approach described in this example may increase driver awareness, thereby increasing safety.

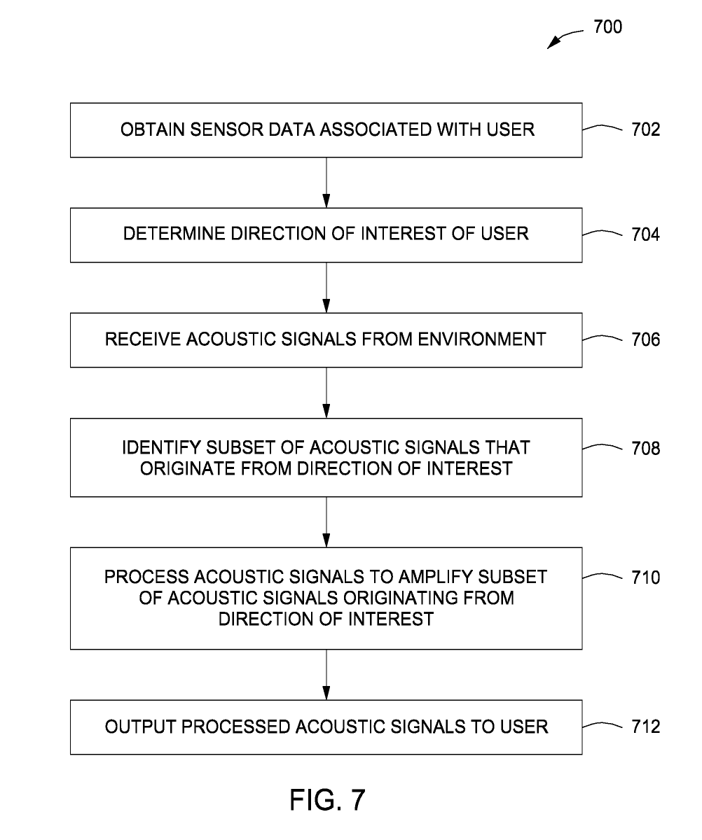

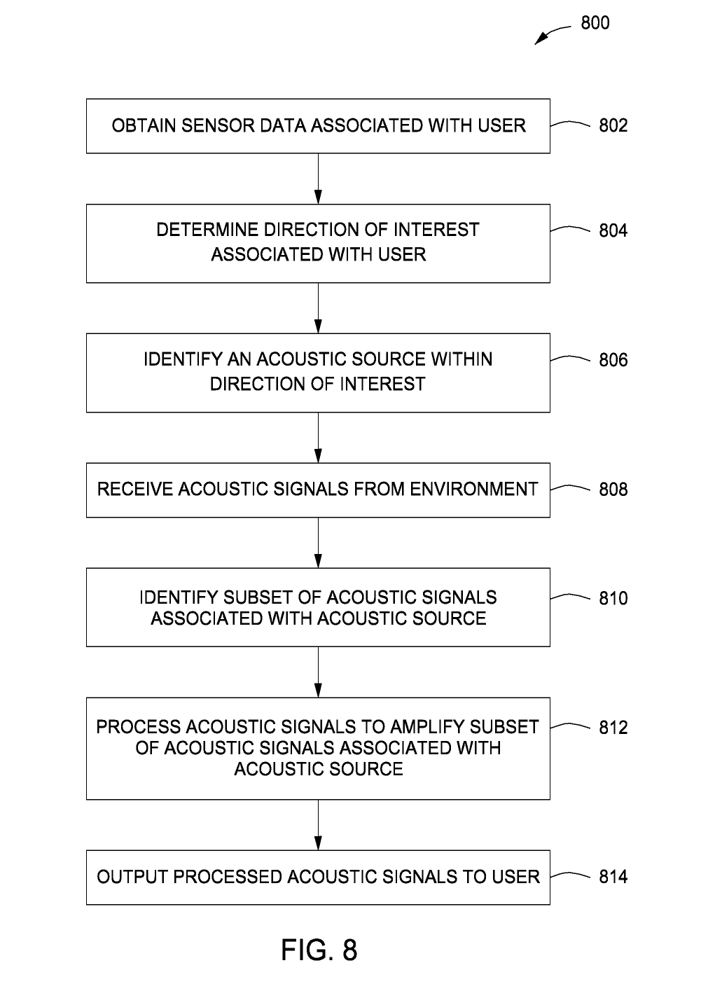

Referring generally to FIGS. 2A-6B, persons skilled in the art will understand that the exemplary usage scenarios described herein provided for the sole purpose of illustrating the operative features of amplification system 100, and are not meant to limit the scope of the various embodiments. Other usage scenarios are also possible, and are not included herein for the sake of brevity. The generic operation of amplification system 100 is described in stepwise fashion below in conjunction with FIGS. 7-8.

### Amplification System Operation

FIG. 7 is a flow diagram of method steps for amplifying acoustic signals derived from a specific direction of interest, according to various embodiments. Although the method steps are described in conjunction with the systems of FIGS. 1-6B, persons skilled in the art will understand that any system configured to perform the method steps, in any order, is within the scope of the disclosed embodiments.

As shown, a method 700 begins at step 702, where inward facing sensors 104 within amplification system 100 obtain sensor data associated with user 130. The sensor data obtained at step 702 may include head orientation data that indicates a direction that user 130 is facing, eye gaze direction data that indicates a direction that user 130 is looking, or data indicating a direction towards which user 130 is pointing or gesturing, among other possibilities. Inward facing sensors 104 obtain sensor data associated with user 130 when coupled to a head-mounted apparatus, such as that shown in FIG. 1C, or when integrated into a vehicle, such as that shown in FIG. 1D.

At step 704, software application 118, when executed by processor 112 within computing device 110 of amplification system 100, determines a direction of interest associated with user 130. The direction of interest could be, for example and without limitation, direction of interest 140 illustrated, by way of example, in FIGS. 2A-2C and 3A-3C, among other places. Generally, the direction of interest determined at step 704 reflects the direction that user 130 is facing or looking. In one embodiment, software application 118 may continuously determine the direction of interest of user 130 for the purposes of continuously amplifying specific acoustic signals. In another embodiment, software application 118 may determine the direction of interest in response to receiving a command from user 130.

At step 706, outward facing sensors 102 within amplification system 100 receive acoustic signals from the acoustic environment that surrounds user 130. The acoustic environment may be a spherical region where acoustic signals originate that surrounds user 130 in 3D space. The acoustic signals received at step 706 may originate from one or more different acoustic sources that reside within that acoustic environment.

At step 708, software application 118 processes the acoustic signals received at step 706 to identify a subset of those acoustic signals that originate from the direction of interest determined at step 704. The subset of acoustic signals identified at step 708 may represent acoustic signals that user 130 (or another person proximate to user 130) may find interesting or deserving of additional attention. In performing step 708, software application 118 may cause outward facing sensors 102 to employ microphone beam forming techniques in order to capture acoustic signals that originate only from the direction of interest determined at step 704.

At step 710, software application 118 processes the acoustic signals received at step 706 to amplify the subset of acoustic signals identified at step 708. In doing so, software application 118 may increase the amplitude of one or more frequencies associated with the subset of acoustic signals, modulate those frequencies to adjust dynamic range, or decrease the amplitude of one or more frequencies not associated with the subset of acoustic signals.

At step 712, software application 118 causes output devices 106 to output the acoustic signals processed at step 710, including the amplified subset of acoustic signals, to user 130. In this manner, amplification system 100 is configured to selectively amplify acoustic signals associated with a direction that user 130 is looking or facing. Amplification system 100 may also selectively amplify acoustic signals associated with a specific acoustic source, as described below in conjunction with FIG. 8.

FIG. 8 is a flow diagram of method steps for amplifying acoustic signals derived from a specific acoustic source of interest, according to various embodiments. Although the method steps are described in conjunction with the systems of FIGS. 1-6B, persons skilled in the art will understand that any system configured to perform the method steps, in any order, is within the scope of the disclosed embodiments.

As shown, a method 800 begins at step 802, where inward facing sensors 104 obtain sensor data associated with user 130. Step 802 of the method 800 is substantially similar to step 702 of the method 700. At step 804, software application 118 processes the sensor data obtained at step 802 and then determines a direction of interest associated with user 130. Step 804 of the method 800 is substantially similar to step 704 of the method 700. As with step 704 of the method 700, in one embodiment, software application 118 may continuously determine the direction of interest of user 130 at step 804. In other embodiments, software application 118 may determine the direction of interest in response to receiving a command from user 130.

At step 806, software application 130 identifies an acoustic source within the direction of interest determined at step 806. In one embodiment, software application 118 may rely on outward facing sensors 102 to capture imaging data associated with the direction of interest determined at step 804. Then, software application 118 may process that imaging data to identify a particular source of the acoustic signals originating from within the direction of interest. Software application 118 may employ computer vision techniques, machine learning, artificial intelligence, pattern recognition algorithms, or any other technically feasible approach to identifying objects from visual data. Software application 118 may then track an identified acoustic source, and implement microphone beam forming techniques to capture acoustic signals specifically generated by that source, as also described below.

In another embodiment, software application may rely on outward facing sensors 102 to capture acoustic data associated with the direction of interest determined at step 804, e.g. via microphone beam forming techniques, without limitation. Then, software application 118 may process that acoustic data to identify a set of frequencies that match a characteristics acoustic pattern derived from a library of such patterns. Each acoustic pattern in the aforesaid library may reflect a set of frequencies associated with a particular real-world object. For example, and without limitation, the library could include a collection of characteristic birdcalls, each being associated with a different type of bird. When software application 118 recognizes a particular acoustic source, software application 118 may then track that source and amplify acoustic signals associated with that source via the following steps of the method 800.

At step 808, outward facing sensors 102 receive acoustic signals associated with the acoustic environment that surrounds user 130. Step 808 may be substantially similar to step 706 of the method 700. At step 810, software application 118 identifies a subset of the acoustic signals received at step 808 that are associated with the acoustic source identified at step 806. In embodiments where software application 118 relies on imaging data captured by outward facing sensors 102 to identify the acoustic source, at step 810, software application 118 may implement a steerable microphone array or a beam forming microphone array to target the acoustic source and capture acoustic signals derived from that source. In embodiments where software application 118 relies on a library of characteristic acoustic patterns to identify acoustic sources, at step 808, software application 118 may process the acoustic signals received at step 808 to identify a set of frequencies that match a characteristic pattern associated with the acoustic source identified at step 806.

At step 812, software application processes acoustic signals received at step 808 to amplify the subset of acoustic signals associated with the acoustic source. In one embodiment, software application 118 may perform step 812 when the acoustic source no longer resides in the direction of interest. For example, user 130 may look directly at a particular bird in hopes of amplifying the birdcall of that bird. Software application 118 could identify the bird at step 806, and then track the bird and corresponding birdcall using the techniques described above. However, if the bird exits the direction of interest of user 130, software application 118 could still track and amplify the birdcall of the bird based on an associated characteristic pattern. In this manner, software application 118 can be configured to track and amplify acoustic sources towards which user 130 is no longer facing or looking. At step 814, output devices 106 output the amplified acoustic signals to user 130.

Referring generally to FIGS. 7 and 8, amplification system 100 can be configured to implement either technique depending on a specific mode of operation. Amplification system 100 may change modes based on user input or based on machine learning decision process that determines the optimal mode for a given situation. In addition, when operating in either mode, amplification system 100 may continuously amplify acoustic signals or only amplify acoustic signals in response to user commands and/or user feedback.

In sum, an amplification system selectively amplifies acoustic signals derived from a particular direction or a particular acoustic source. A user of the amplification system may indicate the direction of interest by facing a specific direction or looking in a particular direction, among other possibilities. The amplification system identifies the direction of interest and may then amplify acoustic signals originating from that direction. The amplification system may alternatively identify a particular acoustic source within the direction of interest, and then amplify acoustic signals originating from that source.

At least one advantage of the disclosed techniques is that the amplification system may eliminate unwanted acoustic signals as well as amplify desirable acoustic signals, thereby providing the user with increased control over the surrounding acoustic environment. Accordingly, the user can more effectively pay attention to acoustic sources that demand increased attention, without the distraction of less relevant acoustic sources. The amplification system may also facilitate higher-quality social interactions, especially for the hearing impaired, by selectively amplifying only the relevant sounds associated with such interactions. Generally, the amplification system of the present disclosure provides the user with a dynamically controlled and flexible acoustic experience.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A non-transitory computer-readable medium storing instructions that, when executed by a processor, configure the processor to selectively amplify acoustic signals by performing the steps of:
determining a direction of interest associated with the user;
identifying, from within a set of acoustic signals associated with a current environment surrounding the user, a subset of acoustic signals associated with the direction of interest;
amplifying the subset of acoustic signals; and
outputting the amplified subset of acoustic signals to the user.

2. The non-transitory computer-readable medium of claim 1, wherein determining the direction of interest associated with the user comprises determining a direction in which the user is facing.

3. The non-transitory computer-readable medium of claim 1, wherein determining the direction of interest of the user comprises determining an eye gaze direction associated with the user.

4. The non-transitory computer-readable medium of claim 1, wherein identifying the subset of acoustic signals comprises:
receiving the set of acoustic signals; and
eliminating one or more acoustic signals from the set of acoustic signals that originate from outside of the direction of interest.

5. The non-transitory computer-readable medium of claim 1, wherein identifying the subset of acoustic signals comprises:
receiving the set of acoustic signals; and
identifying one or more acoustic signals within the set of acoustic signals that originate from an acoustic source that resides within the direction of interest.

6. The non-transitory computer-readable medium of claim 1, wherein amplifying the subset of acoustic signals comprises increasing one or more amplitude values corresponding to one or more frequencies associated with the subset of acoustic signals.

7. The non-transitory computer-readable medium of claim 1, wherein the subset of acoustic signals includes one or more frequencies associated with a first acoustic source that resides within the direction of interest, and wherein amplifying the subset of acoustic signals comprises increasing one or more amplitude values corresponding to the one or more frequencies.

8. The non-transitory computer-readable medium of claim 1, wherein amplifying the subset of acoustic signals comprises decreasing one or more amplitude values associated with one or more frequencies associated with acoustic signals that reside outside of the direction of interest.

9. The non-transitory computer-readable medium of claim 1, wherein outputting the amplified subset of acoustic signals comprises transmitting the amplified acoustic signals to a body-mounted audio output device.

10. The non-transitory computer-readable medium of claim 1, wherein outputting the amplified subset of acoustic signals to the user comprises transmitting the amplified acoustic signals to an in-vehicle audio output device.

11. The non-transitory computer-readable medium of claim 1, further comprising:
determining a second direction of interest associated with the user;
identifying, from within the set of acoustic signals, a second subset of acoustic signals associated with the second direction of interest;
amplifying the second subset of acoustic signals; and
outputting the amplified second subset of acoustic signals to the user.

12. The non-transitory computer-readable medium of claim 1, further comprising:
determining a second direction of interest associated with the user;
continuing to amplify the subset of acoustic signals associated with the direction of interest; and
continuing to output the amplified subset of acoustic signals to the user.

13. The non-transitory computer-readable medium of claim 1, where the amplified subset of acoustic signals represents speech signals generated by a person.

14. A computer-implemented method for selectively amplifying acoustic signals, the method comprising:
determining a direction of interest associated with the user;
identifying, from within a set of acoustic signals associated with a current environment surrounding the user, a subset of acoustic signals associated with the direction of interest;
amplifying the subset of acoustic signals; and
outputting the amplified subset of acoustic signals to the user.

15. The computer-implemented method of claim 14, wherein determining the direction of interest associated with the user comprises determining a direction in which the user is facing, determining an eye gaze direction associated with the user, or determining a direction towards which the user is gesturing.

16. The non-transitory computer-readable medium of claim 1, wherein identifying the subset of acoustic signals comprises:
receiving the set of acoustic signals; and
suppressing, via active noise cancellation, one or more acoustic signals from the set of acoustic signals that originate from outside of the direction of interest.

17. The non-transitory computer-readable medium of claim 1, wherein identifying the subset of acoustic signals comprises:
receiving the set of acoustic signals; and
identifying one or more acoustic signals within the set of acoustic signals having a characteristic set of frequencies corresponding to an acoustic source that resides within the direction of interest.

18. The non-transitory computer-readable medium of claim 1, wherein identifying the subset of acoustic signals comprises identifying, within the set of acoustic signals, one or more acoustic signals that originate from within the direction of interest and reflect off of a surface that resides outside the direction of interest.

19. A system for selectively amplifying acoustic signals, comprising:
a memory storing a software application; and
a processor that is coupled to the memory and, when executing the software application, is configured to:
determine a direction of interest associated with the user,
identify, from within a set of acoustic signals associated with a current environment surrounding the user, a subset of acoustic signals associated with the direction of interest,
amplify the subset of acoustic signals, and
output the amplified subset of acoustic signals to the user.

20. The system of claim 19, wherein the processor is configured to determine the direction of interest by identifying that the user and at least one other person are looking towards the direction of interest.

21. The system of claim 19, wherein the processor is configured to determine the direction of interest by identifying that the user and another person have made eye contact.
